(19) United States
(12) Patent Application Publication
(10) Pub. No.: US 2014/0358662 A1
(43) Pub. Date: Dec. 4, 2014

(54) CONSUMER GAME SYSTEM

(71) Applicant: Sears Brands, L.L.C., Hoffman Estates, IL (US)

(72) Inventor: G. Mercedes De Luca, Pacific Grove, CA (US)

(73) Assignee: Sears Brands, L.L.C., Hoffman Estates, IL (US)

(21) Appl. No.: 14/288,530

(22) Filed: May 28, 2014

Related U.S. Application Data
(60) Provisional application No. 61/829,430, filed on May 31, 2013.

(51) Int. Cl. G06Q 30/02

(52) U.S. Cl. CPC G06Q 30/0226
USPC 705/14.27

(57) ABSTRACT

Systems and methods that support playing of an online game by consumers to qualify for rewards based on the purchase of products in categories represented in cells of an interactive electronic/online game card issued to them by merchant(s) that sponsor the online game. The cells of each online game card appear in a geometric arrangement in which each contains an image, a graphic, and or a textual description representing a product or product category available from the merchant. The consumer may customize their game card(s) to include product categories of specific interest to them, thereby maximizing the reward they may realize. This further promotes consumer exploration of the product offerings of the merchant, resulting in increased likelihood of follow-on purchases from the merchant.

### CROSS-REFERENCE TO RELATED APPLICATIONS

The present application makes reference to, claims benefit of, and claims priority to U.S. Provisional Patent Application No. 61/829,430, filed May 31, 2013, which is hereby incorporated herein by reference, in its entirety.

### FIELD

Certain embodiments of the present disclosure relate to systems and methods that support games that encourage consumer product purchases. More specifically, certain aspects of the present disclosure relate to systems and methods that support playing of an online and/or mobile game by consumers to qualify for rewards based on the purchase of products in categories represented in cells of an interactive electronic/online game card issued to them by merchant(s) that sponsor the online game. The cells of each online game card appear in a geometric arrangement in which each contains an image, a graphic, and or a textual description representing a product or product category available from the merchant. The consumer may customize their game card(s) to include products and product categories of specific interest to them, thereby maximizing the reward they may realize. This further promotes consumer exploration of the product offerings of the merchant, resulting in increased likelihood of follow-on purchases from the merchant.

### BACKGROUND

To promote the sale of products and consumer familiarity with the types of goods available, merchants typically use forms of advertisements in printed media (e.g., newspapers, magazines, direct mail advertisements) or broadcast media (email, radio, television, Internet streamed media). Such advertising is necessarily limited in the breadth of products that can be listed and features products considered selected by the merchant to be of interest to the consumer, which may offer a limited view of the breadth of offerings of the merchant. In addition, to produce sales of the advertised products, the needs and wants of the consumers exposed to such advertisements must coincide with the products chosen for the advertisements in circulation at the moment.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A systems and methods that support playing of an online and/or mobile game by consumers, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is an illustration of computer network, in which a representative embodiment of the present disclosure may be practiced.

FIG. 2 is an illustration of an example online game card, in accordance with a representative embodiment of the present disclosure.

FIG. 3 is an illustration of another example online game card, in accordance with a representative embodiment of the present disclosure.

FIG. 4 is a flowchart illustrating the actions performed by an example method of initializing a game card for a consumer, in accordance with a representative embodiment of the present disclosure.

FIG. 5 is an illustration of an exemplary email that may be used to invite a consumer to participate in a consumer game using an interactive online game card, in accordance with a representative embodiment of the present disclosure.

FIG. 6 shows an illustration of an exemplary web page containing in a center portion a representation of an interactive online game card and in a left portion showing a merchant promotion and notice of loading of a coupon that have been automatically identified as related to products or product categories represented in cells of the interactive online game card, in accordance with a representative embodiment of the present disclosure.

### DETAILED DESCRIPTION

Certain embodiments of the present disclosure relate to systems and methods that support games that encourage consumer product purchases. More specifically, certain aspects of the present disclosure relate to systems and methods that support playing of an online game by consumers to qualify for rewards based on the purchase of products in categories represented in cells of an interactive electronic/online game card issued to them by merchant(s) that sponsor the online game. The cells of each online game card appear in a geometric arrangement in which each contains an image, a graphic, and/or a textual description representing a product or product category available from the merchant. The consumer may customize their game card(s) to include products and product categories of specific interest to them, thereby maximizing the reward they may realize. This further promotes consumer exploration of the product offerings of the merchant, resulting in increased likelihood of follow-on purchases from the merchant. This also promotes a “first stop” shopping behavior where consumers will first check this merchant for items they are seeking vs. going to other sellers so that they can earn rewards more quickly.

The use of various representative embodiments of the present disclosure may be used to drive awareness of the breadth of products offered by the sponsoring merchant(s), and to encourage shopping across the products available from the sponsoring merchant(s). The online game card, or its contents as shown by a mobile application may, for example, be used by the consumer as a “shopping list” when visiting the online or “brick-and-mortar” locations of the sponsoring merchant(s). The online game card can also be used as a “gift registry” list. Members of special affinity or loyalty programs of the sponsoring merchant(s) may be sent invitations to play via, for example, email, when the member has purchased a minimum number of items over a certain period of time (e.g., three items over the past 12 months). Members of affinity or loyalty programs may be provided with additional benefits such an, for example, multipliers on discounts, points, and other prizes, benefits, and incentives based on their completion of their online game card(s), to further encourage their loyalty to and continued business with the sponsoring merchant(s).

In some representative embodiments of the present disclosure, those that are not members of a special affinity or loyalty program may be permitted to participate in a limited way such as, for example, being permitted to play one “row” of the interactive/online game card, and may be rewarded with a “non-points” incentive for that first row. Such non-members may then be required to become a member of the special affinity or loyalty program to play the remaining cells of the interactive/online game card, thereby motivating the consumer to become a member of the special affinity or loyalty program.

Various embodiments of the present disclosure may be used to increase consumer engagement with the sponsoring merchant(s), by encouraging frequent visits to the online interface or mobile application that supports the consumer game of the present disclosure. To further expand interest and participation, the participating consumer is provided with opportunities to engage their social network, encouraging others to participate by notifying them of opportunities to play, and of the prizes and rewards that they themselves have received. These and other aspects of representative embodiments of the present disclosure work to increase retention of customers of the sponsoring merchant(s), to encourage direct contact with the sponsoring merchant(s), and to eliminate intermediaries such as companies that provide search capabilities.

The following description of example methods and apparatus is not intended to limit the scope of the description to the precise form or forms detailed herein. Instead the following description is intended to be illustrative so that others may follow its teachings.

Various aspects of a representative embodiment of the present disclosure are described below in terms of an example “Consumer Game System.” The consumer game system described herein enables sponsoring merchant(s) to promote consumer exploration of the on-line presence of the sponsoring merchant(s) and familiarization with the product categories and products available from the sponsoring merchant(s).

A system in accordance with a representative embodiment of the present disclosure provides for the use of commodity hardware, off the shelf software, operating system (OS) independent applications, form factor independent devices (e.g., personal computers (PCs), tablets, smart phones, etc), media independent (e.g., voice, text, and/or video) and cloud based infrastructure to run all functionalities of the present system. In the context of a consumer engaged in online and in-store shopping with a merchant establishment, such as, for example, a retail business, this is specifically very useful as the consumer can utilize familiar technologies to browse online web sites, engage in in-store access to information about the offerings of the sponsoring merchant(s), and access the functionality of the consumer game system of the present disclosure.

The terms “user,” “end-user,” “customer,” and “consumer” may be used herein to refer to a potential or existing purchaser of products and/or services of a business or merchant.

The term “channel” in the present context may refer to various means of communicating such as, for example, online communication (e.g., Internet-based), mobile communication (e.g., wireless communication such as cellular or Wi-Fi), and in-store communication.

The term “gamification” may be used herein to refer to the use of game thinking and game mechanics in a non-game context in order to engage users and solve problems. Gamification may be used in applications and processes to, for example, improve user engagement, return-on-investment (ROI), data quality, timeliness, and learning.

The terms “cell” and “square” may be used herein interchangeably to refer to both a geometric region or portion of an online game card used to visibly represent information identifying a product, product category, or event, and to any corresponding underlying digital information that identifies the product, product category, or event represented in the visible region or portion of the online game card, when displayed.

The terms “merchant” and “sponsoring merchant/merchants” may be used herein to refer to the owner and/or operator of a business enterprise that either operates a consumer game system as described herein, or enters into an agreement with another to operate such a consumer game system on their behalf.

As utilized herein, the terms “exemplary” or “example” means serving as a non-limiting example, instance, or illustration. As utilized herein, the term “e.g.” introduces a list of one or more non-limiting examples, instances, or illustrations.

It should be noted that the terms “online game card,” “interactive game card,” and “game card” may be used interchangeably in the discussion that follows, whether the consumer accesses, displays, modifies, shares, stores, retrieves, sends, or receives the “online game card,” “interactive game card,”: or “game card” via a web browser of a personal computer connected to the Internet, via a proprietary application the consumer installed on their own handheld device or on a device provided by a sponsoring merchant, via a kiosk in a public area or within a property of a sponsoring merchant, or via other suitable electronic devices on which the “online game card,” “interactive game card,” or “game card” may be accessed. In a representative embodiment of the present disclosure, a representation of the “online game card” may be delivered to the consumer in print form or via email or other electronic means.

A representative embodiment of the present disclosure enables a merchant to provide a consumer with benefits that promote sales of products and at the same time, engage the consumer in a way that helps the consumer to learn about the merchants and the types of products/product categories available from the sponsoring merchant(s), helping to promote further sales.

Some representative embodiments of the present disclosure may have an integrated social media functionality that allows consumers to communicate product, service, manufacturing, sales, and other information with others, and to search for products of interest, poll friends, family, and others, recommend products and receive product recommendations, and plan for and participate in events in their lives and the lives of others.

A representative embodiment of the present disclosure may also provide access to an integrated content management system that provides consumers with product information.

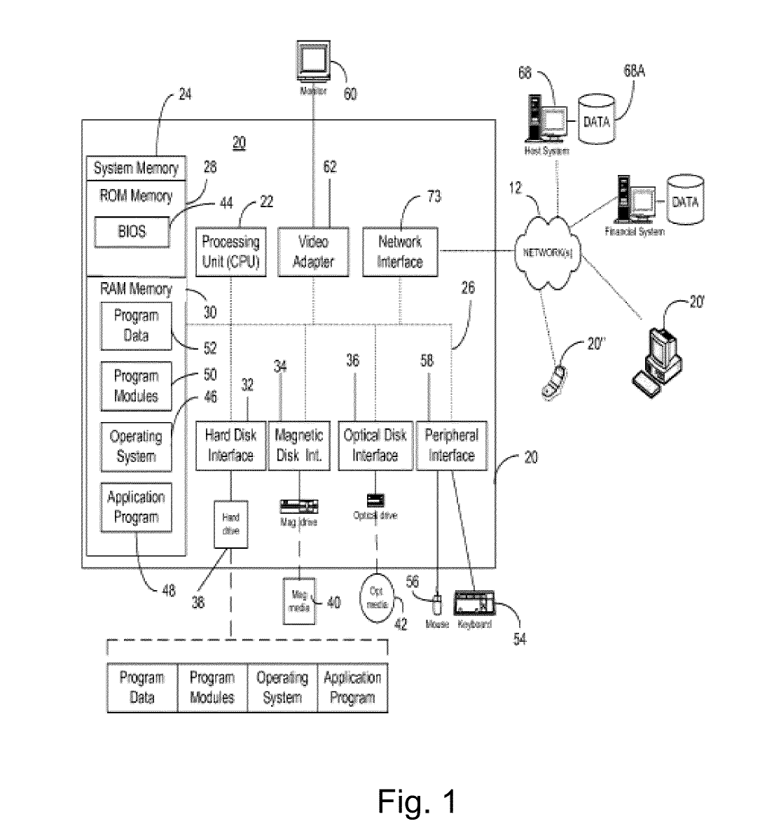

With reference to the figures, and in particular with respect to the exemplary computer network 100 of FIG. 1, the following discloses various example systems and methods that support the operation of a consumer game system as described herein, via a computer network, to various forms of handheld or mobile devices and desktop computers such as those described above. To this end, a processing device 20″, illustrated in the exemplary form of a mobile communication device, a processing device 20′, illustrated in the exemplary form of a computer system, and a processing device 20 illustrated in schematic form, are provided with executable instructions to, for example, provide a means for a customer, e.g., a user, consumer, etc., or a sales associate, a customer service agent, and/or others to access a host system server 68 and, among other things, be connected to an online consumer game system, a content management system, an electronic publication system, a hosted social networking site, storage and management for user profiles, and/or a sales associate. Generally, the computer executable instructions reside in program modules which may include routines, programs, objects, components, data structures, etc. that perform particular tasks or implement particular abstract data types. Accordingly, the processing devices 20, 20′, 20″ illustrated in FIG. 1 may be embodied in any device having the ability to execute instructions such as, by way of example, a personal computer, mainframe computer, personal-digital assistant (“FDA”), cellular telephone, tablet, e-reader, smart phone, or the like. Furthermore, while described and illustrated in the context of a single processing device 20, 20′, 20″, the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices are typically connected to the processing unit 22 by means of an interface 58 which, in turn, is coupled to the bus 26. Input devices may be connected to the processor 22 using interfaces such as, for example, a parallel port, game port, FireWire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system server 68 having associated data repository 68A. In this regard, while the host system server 68 has been illustrated in the exemplary form of a computer, the host system server 68 may, like processing device 20, be any type of device having processing capabilities. Again, the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services, systems of shipping/delivery companies, media content providers, document storage systems, etc.

For performing tasks as needed, the host system server 68 may include many or all of the elements described above relative to the processing device 20. In addition, the host system server 68 would generally include executable instructions for, among other things, coordinating creation, storage, retrieval, and delivery of documents and media content, including the distribution of digital information representing online game cards, social networking, storage of a shopping list, receiving a location of a customer via a mobile device, maintaining transaction histories and customer profiles, receiving a request for a service call center connection from either a customer or a sales associate, routing the request via a distributed mobile video call center, providing a service call infrastructure for providing the requestor with a distributed customer service experience.

Communications between the processing device 20 and the host system server 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, program modules depicted relative to the processing device 20, or portions thereof, may be stored in the non-transitory memory storage device(s) of the host system server 68.

A representative embodiment of the present disclosure may be used to promote consumer activity at both online and traditional “brick-and-mortar” stores, and may result in rewards usable through both channels.

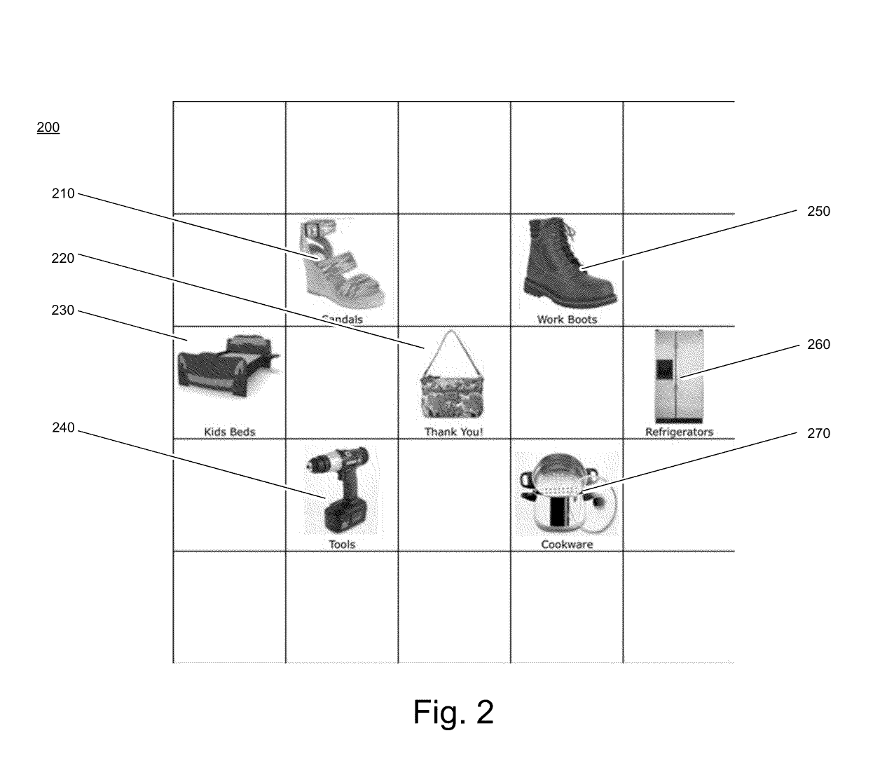

FIG. 2 is a illustration of an example online game card 200 comprising a rectangular grid of cells 210, 220, 230, 240, 250, 260, 270 identifying products or product categories, in accordance with a representative embodiment of the present disclosure. The illustration of FIG. 2 shows a number of product categories including a “Sandals” cell 210, a “Kid's Beds” cell 230, a “Tools” cell 240, a “Work Boots” cell 250, a “Refrigerators” cell 260, and a “Cookware” cell 270. In addition, a center cell 220 for which a product or product category is not identified, is also shown. Although the geometric arrangement of cells in FIG. 2 is shown as a five-by-five rectangular array of cells, this aspect of the example of FIG. 2 does not necessarily represent a specific limitation of the present disclosure, as different geometric arrangements of cells may be employed without departing from the spirit and scope of the present disclosure. In addition, although the example online game card 200 shown in FIG. 2 identifies product categories in only seven of the 25 cells, in some representative embodiments of the present disclosure, a different subset and geometric arrangement of cells may be used and, in some representative embodiments, each of the cells of the online game card 200 may contain an image, a graphic, and/or a textual phrase identifying a product or product category. In a representative embodiment of the present disclosure, clicking on/selection of any cell of an online game card such as, for example, the online game card 200 that identifies a product or product category may, for example, cause display of an assortment of products that fall within the identified product category, products that are similar to the identified product, other product models from the same manufacturer/brand, or additional information about the specific product identified in the cell

In various representative embodiments of the present disclosure, one or more cells of an online game card such as, for example, the online game card 200 may be provided to the consumer in a pre-populated or “personalized” state, in which cells are “covered” or “marked” based upon personal purchase characteristics of the consumer. For example, by way of illustration and not limitation, the personalization may be determined according to prior purchases by the consumer of the specific products or products within the specific product categories identified by those “covered” or “marked” cells. In addition, online game card cells may be populated with products that are frequently purchased together. To enable a consumer game system to personalize online game cards before distribution, the consumer game system may know the consumer, and may itself maintain, or may access stored information maintained by another system that is gathered from online and in-store purchases of consumers. Such gathering may use various types of identifying information such as credit card numbers or loyalty program identifiers to identify consumers.

Alternatively or additionally, one or more cells of the online game card 200 may be pre-populated with products or product categories based not on specific prior purchases by the consumer, but based on consumer demographics, self-identified product/brand preferences, a “wish list” created by the consumer, query or search criteria from a search by the consumer, or even based upon consumer selection of “want,” “like,” or “have/own” icons by the consumer while browsing product information of the sponsoring merchant(s) online, using an “app” on a smart phone or personal computer, or while at an in-store kiosk. Such information about consumers may be gathered and stored in a consumer-specific profile that identifies, by way of example and not limitation, product or brand preferences, style information, level of product quality, size purchased, product price points of products previously searched or purchased by the consumer, and characteristics representative of past consumer purchase selections such as, for example, when multiple similar or competing products were browsed. Such profiles may then be used by a consumer game system of the present disclosure, to select products and/or product categories with which to populate an online consumer game card in accordance with the present disclosure. In yet other representative embodiments of the present disclosure, individuals that are not members of an affinity or loyalty program may be permitted to play a limited number of rows of the online game card, and in some cases may be provided with online game cards in which one or more cells are covered or marked for them, to “seed” the game in a way to help the player.

In a representative embodiment of the present disclosure, the products illustrated in the cells of the online game card 200 may be selected for particular cells of the online game card based on a time of the year (e.g., “back-to-school,” “spring cleanup,” “Memorial Day,” a religious or national holiday), or other point in time having a common theme and set of items typically purchased by consumers.

In some representative embodiments of the present disclosure, the sponsoring merchant may partner with one or more charitable organizations (e.g., “Toys for Tots,” “The Red Cross,” etc.) to create “special” interactive/online game cards that allow a consumer “donor” to purchase some or all of the items identified by cells of the “special” game card and donate any benefits such as those described herein (e.g. rewards, discounts, “points,” etc.) to the charitable organization. The products and/or product categories identified in the cells of the “special” interactive/online game card may be selected by the sponsoring merchant, as described above, or may be selected by the charitable organization. In some representative embodiments, the charitable organization may receive the purchased products and the consumer “donor” may receive the benefits or rewards earned by the consumer playing the interactive/online game card, or the benefits and rewards earned by the consumer “donor” as the consumer “donor” plays the consumer game. This approach may also be used by other organizations (e.g., houses of worship, public and private schools, and others) that may identify their needs and distribute suitable interactive/online game cards to members of the congregation, parents, relatives, etc. Representative embodiments of the present disclosure may also be used by “Lay-Away Angels,” that may re-direct the benefits and rewards described herein that the “Angel” may earn, to designated friends and family, to help them with purchases that the friends and family may be planning.

Although the present application has, up to this point, been described with regard to an exemplary “online” game card, it should be noted that representative embodiments of the present disclosure may include a software application or “app” for a consumer handheld device such as a smart phone, a tablet computer, a laptop computer, a desktop personal computer (PC), or other suitable electronic device that may be used to display and/or update information representing the “online” game card described herein. For example, one or more sponsoring merchant(s) may make available to the consumer a downloadable software application, sometimes referred to as an “app” or a “mobile app,” that may, for example, link with a system supporting the online game card described herein, such as the system 100 of FIG. 1. The “app” may permit the display of, interaction with, and updating of an online game card, and any related elements of an infrastructure such as the system of FIG. 1, so that the consumer may know what product purchases, or purchases within what product categories, would further their progress in “finishing” or “completing” their online game card. The consumer may use capabilities of the handheld device (e.g., the ability to capture an image or scan of identifying information for a product (e.g., a picture of the product, a Universal Product Code (UPC) or other marking, or a product identifier captured using radio frequency identification (RFID) or near field communication (NFC)) to enable the consumer to automatically enter purchases onto their online game card, whether made online or at a “brick-and-mortar” location of the merchant.

In some representative embodiments of the present disclosure using a square grid of cells having an odd number of cells on a side, as shown in example of FIG. 2, the center cell of the grid may be marked or “covered” before or following a first purchase by the consumer from the sponsoring merchant(s), without regard to the product that is purchased.

In a representative embodiment of the present disclosure, “marking” or “covering” every cell in a given row, every cell in a given column, or every cell in a given diagonal may represent “finishing” or “completing” the online game card, and may result in the award of a prize or reward. In other representative embodiments of the present disclosure, the consumer may be awarded a prize or reward upon “marking” or “covering” the four corners and the center cell of a grid, or particular cells of other arrangements of cells, as the arrangements discussed here are offered only as examples, and are not meant to be limiting in any way. Rewards or prizes for “finishing” or “completing” an online game card may include, for example, discounts on future purchases, free shipping of purchases, additional points towards benefits of a points-based customer loyalty program of the sponsoring merchant(s), and one or more “multipliers” that may be applied, for example, to a number of points earned for the value of purchased products shown in the cells of an associated row on the online game card 200, to name just a few. In a representative embodiment of the present disclosure, the prize or reward for finishing an online game card may be different for different arrangements of cells that “mark” or “cover” the cells that finish the online game card. For example, the prize or reward for completely “marking” or “covering” all of the cells of one particular row may be a discount of, by way of example and not limitation, 10% off the amount of the consumer's next purchase, while the prize or reward for “covering” all cells may be, for example, 10,000 reward points for the loyalty program of a sponsoring merchant. Other special prizes or rewards may be given to those consumers that “mark” or “cover” all of the cells of the online game card. Such prizes or rewards may be used, for example, either for online purchases, or for purchases at traditional “brick-and-mortar” locations of the sponsoring merchant(s).

In a representative embodiment of the present disclosure, the consumer may be made aware of, and be encouraged to explore the products of a number of different product categories of the sponsoring merchant(s), by the merchant(s) identifying different product categories in the cells of the online game card 200. For example, in some representative embodiments of the present disclosure, all of the cells of each row or column of the online game card may identify products from a different product category. In other representative embodiments of the present disclosure, each cell of the online game card may identify a different product category, or specify a particular product from a product category different from the other cells of the online game card.

In a representative embodiment of the present disclosure, an online game card such as, for example, the online game card 200 of FIG. 2 of a consumer may be displayed on each product page while the consumer browses the web site of a sponsoring merchant. The consumer may then be allowed to “drag” information identifying a selected product and “drop” such information onto an empty cell of their online game card, thereby placing that product on their online game card, or may choose to replace a product or product category identified by a not yet “marked” or “covered” cell of their online game card. A consumer game system in accordance with a representative embodiment of the present disclosure may notify the consumer when a sponsoring merchant is offering a product identified on their online gamer card, or products in a product category identified on their online game card, at a special or discounted price, or with extra features or attachments, so that the consumer can take advantage of the special product value and permit them to make further progress on “completing” or “finishing” their online game card.

In some representative embodiments of the present disclosure, the appropriate cell(s) of an online game card may automatically be updated as items are selected for purchase such as, for example, by being added to a “shopping cart,” by using the identifying information for each selected item (e.g., stock keeping unit (SKU), item number, manufacturer and product identifier, etc.) and information representing each online game card currently being “played” by or provided to the consumer. That is, a representative embodiment of the present disclosure may maintain a record of all online game cards issued/provided to a particular consumer, keeping track of those that have been “finished” but for which the prizes or rewards have not yet been used, those that have been “finished” and for which the prizes or rewards have been used, and those that have been issued/provided but that have not yet qualified for any prizes or rewards.

In a representative embodiment of the present disclosure, the consumer may be permitted to replace the product or product category identified by a cell that has not yet been “marked” or “covered” with a different product or product category. This may be used to permit the consumer to swap out cells identifying products or product categories on the online game card provided to them by the sponsoring merchant(s), which may not relate to the interests or needs of the consumer, with products or product categories in which they have interest or need, further encouraging the consumer to make additional purchases from the inventory of the sponsoring merchant(s). In some representative embodiments of the present disclosure, cells that are “marked” or “covered” or, that is, for which qualifying products (i.e., products that match the identified product, or fit within a product category identified by the cell) have already been purchased, may not be replaced.

To encourage the consumer to log on to the web site(s) of the sponsoring merchant(s), or to check a downloaded game card on their handheld device, on a regular basis (e.g., one a day, twice a day, weekly, at least twice a week, at least N times a month), certain cells of the online game card may be specific to a particular time period, or the product or product category of some cell(s) may change, for example, every hour, every day, each week, or on another schedule, or at times determined on the basis of a random event generator, or the whim of the sponsoring merchant(s).

In some representative embodiments of the present disclosure, the consumer game system may automatically replace an identified product or product category of a cell not yet “marked” or “covered” by a corresponding consumer purchase, with an image, photo, or text such as “Wild Card!,” giving the consumer an extra “marked” or “covered,” moving them closer to a “finished” or “completed” card, and a corresponding prize or reward.

In a representative embodiment of the present disclosure, a representation or image of the consumer's current online game card may be displayed, for example, following logon to the web site of one of the sponsoring merchant(s), and/or on each web page of the web site of a sponsoring merchant while shopping online, in order to remind them to make purchases of the identified products or of products in the identified product categories, to aid the consumer in making progress towards the rewards provided when they “finish” or “complete” their online game card. The representation or image of the online game card presented on the “logon” page may be a relatively larger image, while the representation or image on each displayed web page may be a relatively smaller image (e.g., what may be referred to as a “thumbnail”), and either representation of the online game card may be accompanied by messages reminding the consumer how close they are to “finishing” or “completing” the displayed online game card (e.g., “You′re just one square from a prize!”, “Filling in two more squares qualifies you for free shipping!”). In some representative embodiments of the present disclosure, the user may be told the products or product categories in which a purchase would result in a reward or prize.

In some representative embodiments of the present disclosure, the later return of previously purchased products to the sponsoring merchant(s) by a consumer may cause one or more cells of the consumer's online game card(s) that were “marked” or “covered” by prior purchase(s) of the consumer, to be returned to a “not marked” or “not covered” state. That is, in a representative embodiment of the present disclosure, if a consumer purchases a particular product that results in the “covering” or “marking” of a cell on one or more of their online game cards, and the consumer later returns the purchased product that caused the “covering” or “marking” of one or more cells, those “covered” or “marked” cells may be returned to a “not covered” or “not marked” state, when feasible. In some representative embodiments of the present disclosure, a cell or square may be “marked” or “covered” upon shipment of a product to the consumer.

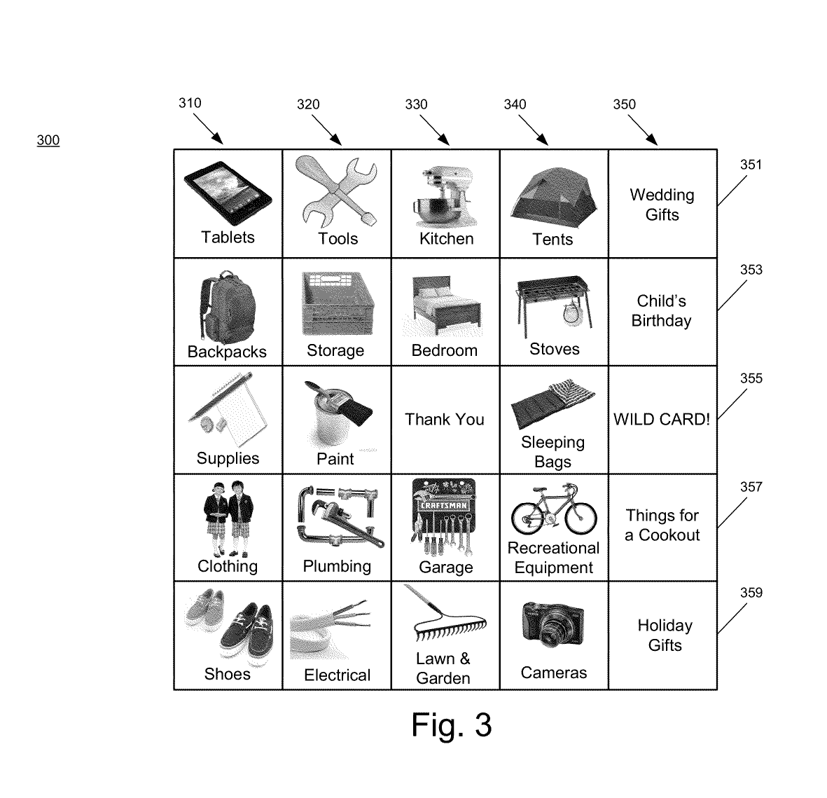

FIG. 3 is an illustration of another example online game card 300, in accordance with a representative embodiment of the present disclosure. The online game card 300 is similar to the online game card 200 of FIG. 2, however all cells or squares of the online game card 300 are occupied and have been arranged so that the cells or squares of each of the columns 310, 320, 330, 340, 350 have a common or shared theme. For example, the products of column 310 are all “back-to-school” items, while the cells of column 320 identify product categories related to maintaining a residence or small business. The cells of column 330, which includes a “free” cell simply labeled “Thank You”, are related to things for a home, while the cells of column 340 identify product categories that a consumer may want to purchase when planning a vacation trip. Finally, the cells of column 350, which include a “WILD CARD!” cell 355, which may be “marked” or “covered” by any purchase, identify product purchases related to events in one's life such as a “Wedding Gifts” cell 351, a “Child's Birthday” cell 353, a “Thing for a Cookout” cell 357, and a “Holiday Gifts” cell 359. It should be noted that the particular product categories and events shown in the cells of the online game card 300 of FIG. 3 are by way of example and not limitation, and do not necessarily represent limitations of the present disclosure, and that other products, product categories, events, and/or other types of cells may be used without departing from the spirit and scope of the present disclosure.

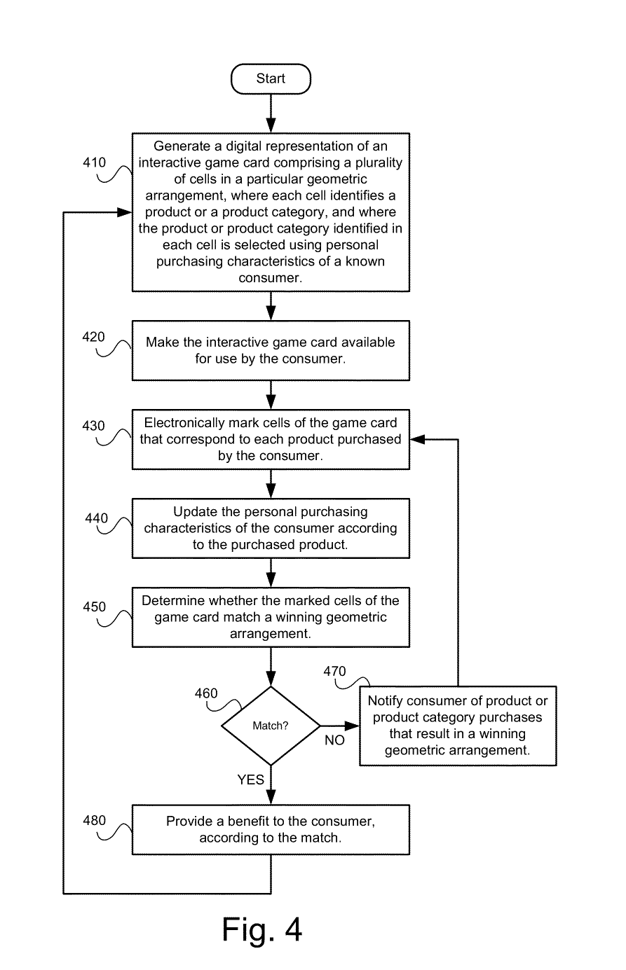

FIG. 4 is a flowchart 400 illustrating a exemplary method of operating a consumer game system, in accordance with a representative embodiment of the present disclosure. The following description of the method of FIG. 4 may make reference to the elements of FIGS. 1, 2, and 3.

The method of FIG. 4 begins at block 410, where a consumer game system in accordance with a representative embodiment of the present disclosure may generate a digital representation of an interactive/online game card comprising a plurality of cells in a particular geometric arrangement, such as the online game cards 200, 300 of FIGS. 2 and 3. Each cell of such an online game card may identify a product or a product category, and the product or product category identified in each cell may be selected using personal purchasing characteristics and game board actions and choices of a consumer. As described above, in some representative embodiments, the consumer may be known to the consumer game system, and the personal purchasing characteristics of the consumer used to select the products or product categories for each cell may, for example, comprise information about prior purchases, self-identified product, price-point, style, designer, and/or brand preferences, and other factors previously discussed. A consumer game system in accordance with a representative embodiment of the present disclosure may select products and/or product categories for the cells of an interactive/online game card not only from the purchase history of the individual consumer, but also from the additions, deletions, and/or changes made by the consumer to the products and/or product categories represented by the cells of their interactive/online game card(s), and also by the additions, deletions, and/or changes made by other participants in the consumer game.

Next, at block 420, the method of FIG. 4 makes the interactive/online game card available for use by the consumer. This may be accomplished by, for example, displaying it on one or more web pages of a web site of a sponsoring merchant, or downloading and displaying it via, for example, a software application or “app” on a handheld electronic device such as a smart phone (e.g., Apple iPhone®, Samsung Galaxy SIII), a media player (e.g., Apple iTouch®), a tablet computer (e.g., Apple iPad®), an e-reader (e.g., Nook®, Kindle®, etc.), a laptop computer, a netbook computer, a notebook computer, a desktop computer, or other suitable electronic device.

At block 430, the method of FIG. 4 may electronically “mark” or “cover” cells of the game card that correspond to each product purchased by the consumer, whether purchased online, at a kiosk, at a “brick-and-mortar” location of the merchant, or via another mechanism. Such “marking” may include placing a particular symbol within a cell, using a signifying color in representing the cell or its border, changing the image shown in a cell in particular manner (e.g., adding a “check” or other distinctive mark), or other suitable visible designation. Next, at block 440, the method may update the personal purchasing characteristics of the consumer according to the purchased product. In this manner, the consumer game system learns consumer buying preferences and habits from the nature of the purchased products, and modifies the products and/or product categories selected for cells of the current and future online game cards, and appropriate prizes, rewards, and incentives that work best in engaging, retaining, and motivating the consumer in their participation with the sponsoring merchant(s).

The method, at block 450, determines whether the “marked” or “covered” cells of the interactive/online game card match a winning geometric arrangement. As discussed above, for a rectangular grid of cells, example winning geometric cell arrangements may include “marking” or “covering” all cells in a given column, row, or diagonal, four corner cells and the center cell, or any other geometric arrangement defined by the sponsoring merchant(s) or an agent operating the consumer game. Non-rectangular grids of cells may also be used. If a match if found, then at block 460, the method continues on to block 480, where the method provides a benefit to the consumer, according to the match determined at block 450 The method then continues by returning to block 410. If a winning match is not found, then at block 460, the method continues on to block 470, where the method of FIG. 4 notifies the consumer of possible product or product category purchases that result in a winning geometric arrangement. In this way, the method of FIG. 4 reminds the consumer of what is needed to win a reward or prize. The method of FIG. 4 then continues at block 430, described above.

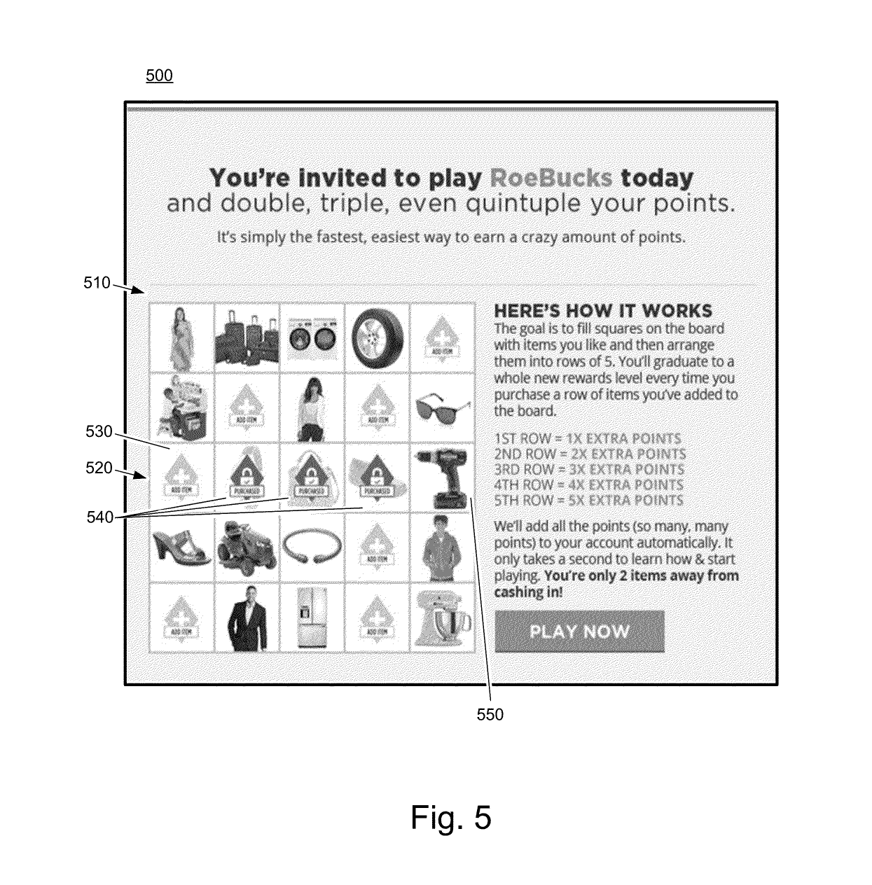

FIG. 5 is an illustration of an exemplary email 500 that may be used to invite a consumer to participate in a consumer game using an interactive online game card 510, in accordance with a representative embodiment of the present disclosure. The invitation email 500 illustrated in FIG. 5 includes a representation of an interactive online game card 510. The example interactive online game card 510 of FIG. 5 includes a row 520 in which three cells have been marked or covered. This may be done before the email is sent to the recipient by the sponsor/operator of the consumer game, to place the recipient in a situation where they may “win” by simply making two purchases, one of the product represented in cell 550, and one of a product item of their choice that they may add to cell 530, in order to complete row 520. Again, it should be noted that although the example of FIG. 5 shows a five cell by five cell rectangular array of cells with a particular arrangement of represented products and various cell states, this is for illustrative purposes only, and does not represent a specific limitation of the present disclosure, as other numbers, arrangements, and representations of products and/or product categories may be used without departing from the spirit and scope of the present disclosure.

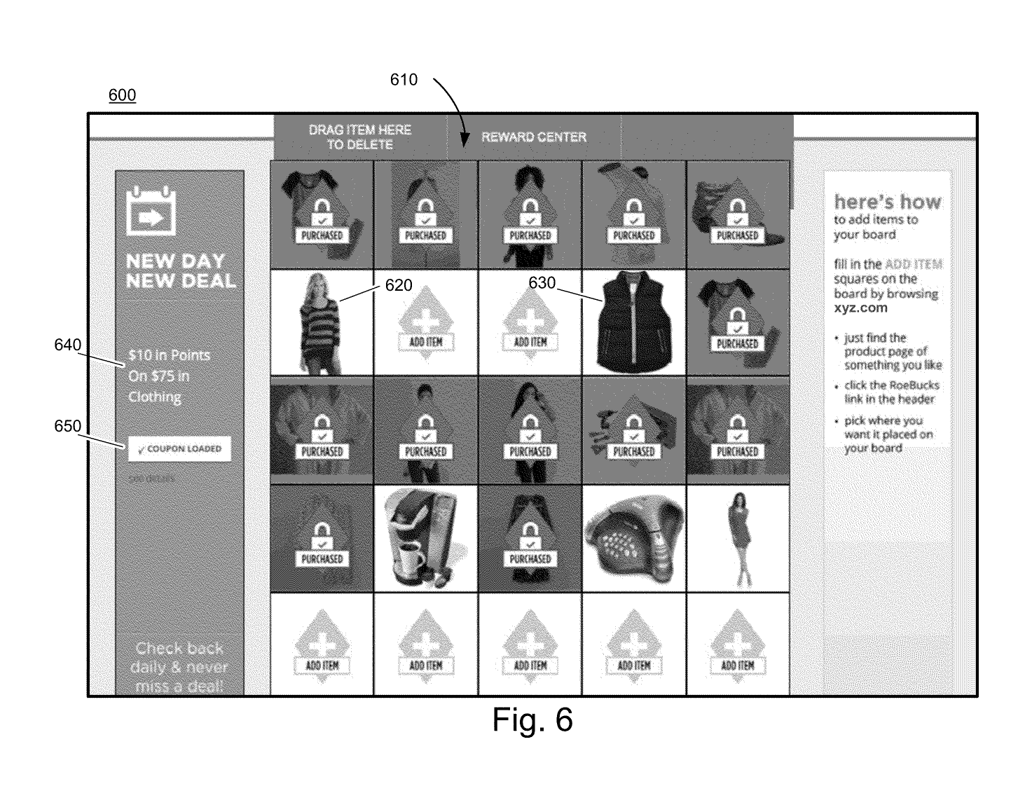

FIG. 6 shows an illustration of an exemplary web page 600 containing, in a center portion, a representation of an interactive online game card 610 and, in a left portion, a merchant promotion 640 and notice of the loading of a coupon 650 that may have been automatically identified as related to products or product categories represented in cells 620, 630 of the online game card 610, in accordance with a representative embodiment of the present disclosure. In a representative embodiment of the present disclosure, a system such as the host system 68 of FIG. 1 may search for and identify any “promotions” (e.g., as shown in the left portion of FIG. 6) that are related or tied to, by way of example and not limitation, any existing promotions currently available from the merchant, and in addition, those promotions or offers that are specifically related or tied to product items or product categories that are represented on the interactive online game card of the consumer, such as the items of clothing illustrated in the cells 620, 630 of the interactive online game card 610. In this way, a representative embodiment of the present disclosure may help to “incent” members participating in the consumer game of the present disclosure to return to the merchant web site often and check their interactive online game card such as interactive game card 610 for additional promotions or offers. As illustrated in the exemplary embodiment of FIG. 5, an interactive game card may be accompanied by information that tells participants in the consumer game how many additional points they can earn by completing each row of the interactive online game card. As shown in the left portion of the web page 600, participants in the consumer game may receive a “coupon” at the time of checkout, in response to the purchase of a product item specifically represented or belonging to a product category represented in the cells of the interactive online game card 610.

Aspects of the present disclosure may be seen in a method for operating a consumer game system. Such a method may comprise generating a digital representation of an interactive game card comprising a plurality of cells in a particular geometric arrangement, wherein each cell of the plurality of cells is representative of a product or a product category, and making the interactive game card available for use by a consumer. The method may also comprise electronically marking one or more cells of the plurality of cells of the interactive game card that correspond to each product purchased by the consumer, determining whether marked cells of the plurality of cells of the interactive game card match a winning geometric arrangement, and providing notification to the consumer according to the determination. In various representative embodiments of the present disclosure, the initial product or product category identified in each cell of the plurality of cells may be selected for the consumer using personal purchasing characteristics of the consumer, where the personal purchasing characteristics of the consumer may be representative of one or both of online and in-store purchasing behavior of the consumer.

In a representative embodiment of the present disclosure, making the interactive game card available for use by the consumer may comprise marking a first set of cells of the plurality of cells, if the consumer is not a member of a loyalty program of a sponsor of the consumer game system, and marking a second set of cells of the plurality of cells that is different from the first set of cells of the plurality of cells, if the consumer is a member of the loyalty program of the sponsor of the consumer game system. Electronically marking one or more cells of the plurality of cells of the interactive game card that correspond to each product purchased by the consumer may comprise updating the personal purchasing characteristics of the consumer according to the purchased product. Providing notification to the consumer according to the determination may comprise providing a benefit to the consumer, if it is determined that marked cells of the plurality of cells of the interactive game card match a winning geometric arrangement, and providing notification to the consumer according to the determination may comprise notifying the consumer of product or product category purchases that result in a winning geometric arrangement, if it is determined that marked cells of the plurality of cells of the interactive game card do not match a winning geometric arrangement. In some representative embodiments of the present disclosure, the particular geometric arrangement may be a five cell by five cell rectangular array, and the method may further comprise automatically replacing the represented product or product category of a cell of the plurality of cells that is not marked, with a representation that matches one or both of all products and all product categories.

Additional aspects of the present disclosure may be seen in a non-transitory computer readable medium having stored thereon a plurality of instructions executable by at least one processor, the instructions for causing the at least one processor to perform actions of the method set forth above.

Yet other aspects of the present disclosure may be seen in a system for operating a consumer game system, in which the system comprises at least one processor for communicative coupling to an electronic device of a consumer. In such a system, the at least one processor may be operable to perform the actions of the method described above.

Although devices, methods, and systems according to the present disclosure may have been described in connection with a preferred embodiment, it is not intended to be limited to the specific form set forth herein, but on the contrary, it is intended to cover such alternative, modifications, and equivalents, as can be reasonably included within the scope of the disclosure as defined by this disclosure and appended diagrams.

Accordingly, the present disclosure may be realized in hardware, software, or a combination of hardware and software. The present disclosure may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for operating a consumer game system, the method comprising:
generating a digital representation of an interactive game card comprising a plurality of cells in a particular geometric arrangement, wherein each cell of the plurality of cells is representative of a product or a product category;
making the interactive game card available for use by a consumer;
electronically marking one or more cells of the plurality of cells of the interactive game card that correspond to each product purchased by the consumer;
determining whether marked cells of the plurality of cells of the interactive game card match a winning geometric arrangement; and
providing notification to the consumer according to the determination.

2. The method according to claim 1, wherein the initial product or product category identified in each cell of the plurality of cells is selected for the consumer using personal purchasing characteristics of the consumer.

3. The method according to claim 2, wherein the personal purchasing characteristics of the consumer are representative of one or both of online and in-store purchasing behavior of the consumer.

4. The method according to claim 1, wherein making the interactive game card available for use by the consumer comprises marking a first set of cells of the plurality of cells, if the consumer is not a member of a loyalty program of a sponsor of the consumer game system, and marking a second set of cells of the plurality of cells that is different from the first set of cells of the plurality of cells, if the consumer is a member of the loyalty program of the sponsor of the consumer game system.

5. The method according to claim 1, wherein electronically marking one or more cells of the plurality of cells of the interactive game card that correspond to each product purchased by the consumer comprises updating the personal purchasing characteristics of the consumer according to the purchased product.

6. The method according to claim 1, wherein providing notification to the consumer according to the determination comprises providing a benefit to the consumer, if it is determined that marked cells of the plurality of cells of the interactive game card match a winning geometric arrangement.

7. The method according to claim 6, wherein providing notification to the consumer according to the determination comprises notifying the consumer of product or product category purchases that result in a winning geometric arrangement, if it is determined that marked cells of the plurality of cells of the interactive game card do not match a winning geometric arrangement.

8. The method according to claim 1, wherein the particular geometric arrangement is a five cell by five cell rectangular array.

9. The method according to claim 1, wherein the method further comprises automatically replacing the represented product or product category of a cell of the plurality of cells that is not marked, with a representation that matches one or both of all products and all product categories.

10. A non-transitory computer readable medium having stored thereon a plurality of instructions executable by at least one processor, the instructions for causing the at least one processor to perform actions of a method for operating a consumer game system, the actions comprising:
generating a digital representation of an interactive game card comprising a plurality of cells in a particular geometric arrangement, wherein each cell of the plurality of cells is representative of a product or a product category;
making the interactive game card available for use by a consumer;
electronically marking one or more cells of the plurality of cells of the interactive game card that correspond to each product purchased by the consumer;
determining whether marked cells of the plurality of cells of the interactive game card match a winning geometric arrangement; and
providing notification to the consumer according to the determination.

11. The non-transitory computer readable medium according to claim 10, wherein the initial product or product category identified in each cell of the plurality of cells is selected for the consumer using personal purchasing characteristics of the consumer.

12. The non-transitory computer readable medium according to claim 11, wherein the personal purchasing characteristics of the consumer are representative of one or both of online and in-store purchasing behavior of the consumer.

13. The non-transitory computer readable medium according to claim 10, wherein making the interactive game card available for use by the consumer comprises marking a first set of cells of the plurality of cells, if the consumer is not a member of a loyalty program of a sponsor of the consumer game system, and marking a second set of cells of the plurality of cells that is different from the first set of cells of the plurality of cells, if the consumer is a member of the loyalty program of the sponsor of the consumer game system.

14. The non-transitory computer readable medium according to claim 10, wherein electronically marking one or more cells of the plurality of cells of the interactive game card that correspond to each product purchased by the consumer comprises updating the personal purchasing characteristics of the consumer according to the purchased product.

15. The non-transitory computer readable medium according to claim 10, wherein providing notification to the consumer according to the determination comprises providing a benefit to the consumer, if it is determined that marked cells of the plurality of cells of the interactive game card match a winning geometric arrangement.

16. The non-transitory computer readable medium according to claim 15, wherein providing notification to the consumer according to the determination comprises notifying the consumer of product or product category purchases that result in a winning geometric arrangement, if it is determined that marked cells of the plurality of cells of the interactive game card do not match a winning geometric arrangement.

17. The non-transitory computer readable medium according to claim 10, wherein the particular geometric arrangement is a five cell by five cell rectangular array.

18. The non-transitory computer readable medium according to claim 10, wherein the actions further comprise automatically replacing the represented product or product category of a cell of the plurality of cells that is not marked, with a representation that matches one or both of all products and all product categories.

19. A system for operating a consumer game system, the system comprising:
at least one processor for communicative coupling to an electronic device of a consumer, the at least one processor operable to, at least:
generate a digital representation of an interactive game card comprising a plurality of cells in a particular geometric arrangement, wherein each cell of the plurality of cells is representative of a product or a product category;
make the interactive game card available for use by a consumer;
electronically mark one or more cells of the plurality of cells of the interactive game card that correspond to each product purchased by the consumer;
determine whether marked cells of the plurality of cells of the interactive game card match a winning geometric arrangement; and
provide notification to the consumer, via the electronic device, according to the determination.

20. The system according to claim 19, wherein the initial product or product category identified in each cell of the plurality of cells is selected for the consumer using personal purchasing characteristics of the consumer.

21. The system according to claim 20, wherein the personal purchasing characteristics of the consumer are representative of one or both of online and in-store purchasing behavior of the consumer.

22. The system according to claim 19, wherein making the interactive game card available for use by the consumer comprises marking a first set of cells of the plurality of cells, if the consumer is not a member of a loyalty program of a sponsor of the consumer game system, and marking a second set of cells of the plurality of cells that is different from the first set of cells of the plurality of cells, if the consumer is a member of the loyalty program of the sponsor of the consumer game system.

23. The system according to claim 19, wherein electronically marking one or more cells of the plurality of cells of the interactive game card that correspond to each product purchased by the consumer comprises updating the personal purchasing characteristics of the consumer according to the purchased product.

24. The system according to claim 19, wherein providing notification to the consumer according to the determination comprises providing a benefit to the consumer, if it is determined that marked cells of the plurality of cells of the interactive game card match a winning geometric arrangement.

25. The system according to claim 24, wherein providing notification to the consumer according to the determination comprises notifying the consumer of product or product category purchases that result in a winning geometric arrangement, if it is determined that marked cells of the plurality of cells of the interactive game card do not match a winning geometric arrangement.

26. The system according to claim 19, wherein the particular geometric arrangement is a five cell by five cell rectangular array.

27. The system according to claim 19, wherein the at least one processor is further operable to, at least, automatically replace the represented product or product category of a cell of the plurality of cells that is not marked, with a representation that matches one or both of all products and all product categories.
